(19) United States
(12) Patent Application Publication
(10) Pub. No.: US 2015/0114332 A1
(43) Pub. Date: Apr. 30, 2015

(54) IGNITION DEVICE FOR IGNITING FUEL/AIR MIXTURES IN A COMBUSTION CHAMBER OF AN INTERNAL COMBUSTION ENGINE BY CORONA DISCHARGE

(71) Applicant: BorgWarner Ludwigsburg GmbH, Ludwigsburg (DE)

(72) Inventors: Timo Stifel, Stuttgart (DE); Alexander Schenk, Waiblingen (DE)

(21) Appl. No.: 14/525,349

(22) Filed: Oct. 28, 2014

(30) Foreign Application Priority Data
Oct. 31, 2013 (DE) 10 2013 112 051.2
Aug. 20, 2014 (DE) 10 2014 111 897.9

(51) Int. Cl. F02P 23/04; H01T 19/00

(52) U.S. Cl. CPC F02P 23/04; H01T 19/00
USPC 123/143 B

(57) ABSTRACT

Ignition device for igniting fuel/air mixtures in a combustion chamber of an internal combustion chamber by a corona discharge. The device includes an ignition electrode and an outer conductor surrounding the ignition electrode. The outer conductor has a front end and a rear end, and comprises an electrical insulator arranged between the ignition electrode and the outer conductor, from which insulator at least one tip of the ignition electrode protrudes. The at least one tip of the ignition electrode is arranged in a space that is shielded by a cap associated with the insulator, said cap having an inner side facing the insulator and an outer side facing away from the insulator as well as one or more holes, by means of which the shielded space is connected to a space arranged on the outer side of the cap.

### RELATED APPLICATIONS

This application claims priority to DE 10 2013 112 051.2, filed Oct. 31, 2013, and also claims priority to DE 10 2014 111 897.9, filed Aug. 20, 2014, both of which are hereby incorporated herein by reference in their entireties.

### BACKGROUND

The invention relates to an ignition device for igniting air/fuel mixtures in a combustion engine, devices of this type being generally known from DE 10 2010 045 170 B3. Ignition devices of this type are referred to as corona ignition devices or HF ignition devices.

The document DE 10 2010 045 170 B3 discloses how a fuel/air mixture in a combustion chamber of an internal combustion engine can be ignited by a corona discharge produced in the combustion chamber. For this purpose, an ignition electrode is passed in an electrically insulated manner through walls of the combustion chamber at ground potential and protrudes into the combustion chamber, preferably opposite a reciprocating piston provided in the combustion chamber. The ignition electrode forms an electrical capacitor together with the walls of the combustion chamber at ground potential as counter electrode. The insulator surrounding the ignition electrode and the combustion chamber with the contents thereof act as a dielectric. Depending on the stroke in which the piston is located, air or a fuel/air mixture or an exhaust gas is located in the combustion chamber.

The capacitor is part of an electric resonating circuit, which is excited with a high-frequency voltage, which is produced for example with the aid of a transformer with center tap. The transformer cooperates with a switching device, which applies alternately a predefinable DC voltage to two primary windings of the transformer separated by the center tap. The secondary winding of the transformer feeds a series resonating circuit, in which the capacitor formed from the ignition electrode and the walls of the combustion chamber is located. The frequency of the AC voltage exciting the resonating circuit is controlled such that it lies as close as possible to the resonance frequency of the resonating circuit. This results in a voltage excess between the ignition electrode and the walls of the combustion chamber, in which the ignition electrode is arranged. The resonance frequency is typically between 500 kHz and 5 MHz and the AC voltage at the ignition electrode reaches values from, for example, 10 kV to 100 kV. A corona discharge can thus be produced in the combustion chamber. In contrast to a spark discharge, in the case of a corona discharge a voluminous charge carrier cloud is produced, from which the ignition starts. An advantage of corona ignition is that the ignition of the fuel/air mixture starts from a volume, in contrast to a conventional spark plug, in which the ignition of the fuel/air mixture occurs at a single point by an ignition spark. Hence it is said that corona ignition has a spatial ignition characteristic.

The ignition tips of corona ignition devices are sensitive. This is true in particular for ignition devices having a number of ignition tips. In order to protect the ignition tips against damage, DE 10 2010 05 170 B3 proposes embedding the ignition electrode, including the tips thereof, in the insulator. This is achieved for example by plugging an unbranched portion of the ignition electrode in a ceramic insulator block and then injecting an insulator material, for example based on aluminium oxide, around a branched portion of the ignition electrode, followed by sintering. The ends of the pointed electrode branches are then freed from insulator material by abrasion.

This structure of corona ignition devices offers effective protection for the tips of the ignition electrodes, but is associated with considerable outlay.

### SUMMARY

This disclosures teaches a solution for the protection of the tips of ignition electrodes that is associated with lower outlay.

An ignition device according to this disclosure, which ignites a fuel/air mixture in a combustion chamber of an internal combustion engine by a corona discharge, has an ignition electrode, an outer conductor surrounding the ignition electrode, said outer conductor having a front end and a rear end, and an electrical insulator arranged between the ignition electrode and the outer conductor. The ignition electrode has one or more tips, which protrude from the insulator. The one tip of the ignition electrode or the plurality of tips of the ignition electrode is/are protected in that they are arranged in a space that is shielded by a cap associated with the insulator of the ignition device, said cap having an inner side facing the insulator and an outer side facing away from the insulator as well as one or more holes, by means of which the shielded space is connected to a space arranged on the outer side of the cap. When the ignition device is installed as intended in an internal combustion engine, the space on the outer side of the cap is a combustion chamber of the internal combustion engine.

If it has only a single tip, the ignition electrode can protrude via this one tip into the space shielded by the cap. If the ignition electrode branches, such that it has a plurality of pointed branches, these can be arranged completely outside the insulator in the space shielded by the cap.

This disclosure provides a number of advantages:
although the ignition electrode protrudes from the insulator via one or more tips, it is still effectively protected by the cap associated with the insulator.
it is easier to produce the cap than to embed the electrode up to the tips thereof in an insulator.
since the cap has one or more holes, it does not hinder the ignition of the fuel/air mixture. By contrast, it has been found that a cap provided in accordance with this disclosure even improves and can accelerate the ignition process. The corona discharge forming in the relatively small space shielded by the cap first ignites the fuel/air mixture provided in said space, and this occurs as a result of the expansion of the corona filling the entire shielded space very quickly. The associated extremely quick pressure increase in the space shielded by the cap means that hot torch jets shoot from the shielded space through the holes in the cap into the actual combustion chamber of the engine, where they cause an ignition, which spreads very quickly in the entire combustion chamber, of the fuel/air mixture. This results in the following further advantages:
   the efficacy of the combustion in the combustion chamber of the internal combustion engine is increased,
   mixtures can be ignited that are much leaner than previously,
   an ignition of mixtures in larger combustion chambers is facilitated,
   the harmful emissions of the internal combustion engine are reduced,
   smaller fluctuations during the course of the ignition and combustion process occur from cycle to cycle of the internal combustion engine, which consequently facilitates the engine control and allows the engine to be operated closer to the knocking limit of the engine. Thus fuel consumption can be reduced.
With corona ignition, the size of the corona and therefore the spatial ignition character thereof decreases with rising pressure in the fuel/air mixture, whereby the quality of the ignition by corona ignition reduces with increasing pressures and with increasing size of the combustion chamber volume. This is counteracted by the provision of the cap according to this disclosure, since this causes an initial ignition to always take place in the space shielded by the cap and to then spread quickly in the entire combustion chamber due to the hot torch jets, which shoot through the holes in the cap from the shielded space into the combustion chamber outside the cap. In this way, the spatial ignition character of the ignition initiated by a corona discharge is maintained by the provision of the cap, and this disclosure broadens the possibility for use of the corona ignition both to internal combustion engines with larger combustion chambers and to internal combustion engines in which higher pressures occur.
The wear of the tips of the ignition electrode is smaller than with an ignition device without cap, because the temperature load of the tips of the ignition electrode in the cap is kept lower than outside the cap.

Ignition devices according to this disclosure can therefore be used in particular in internal combustion engines in which the pressure of the fuel/air mixture in the compression stroke reaches at least 50 bar. This concerns large stationary gas engines in particular, in which a pressure up to 100 bar can prevail at the moment of ignition. Previously, large stationary gas engines were ignited using spark plugs. In order to operate said engines with leaner mixtures, which cannot be ignited so well by a spark plug, it is known to provide the spark plug in a pre-chamber, to which fuel gas is additionally supplied, such that a fuel/air mixture with a higher proportion of fuel gas than in the primary combustion chamber is present in the pre-chamber (referred to as a gas-flushed pre-chamber). A corona ignition device according to this disclosure allows to extend the operating range of the ignition in large stationary gas engines to larger cylinder capacities and/or to much leaner mixtures, without having to use pre-chambers flushed with fuel gas.

The outer conductor surrounding the insulator in the ignition device according to this disclosure is usually a housing of the ignition device, which can have an external thread on the front end thereof, by means of which the ignition device can be screwed into a matching internal thread in the cylinder head of the internal combustion engine. The housing/the outer conductor usually consists of steel. The cap preferably consists of the same material as the outer conductor/the housing. The cap can be welded to the front end of the housing/the outer conductor.

The ignition electrode is preferably branched into a number of tips, which protrude into the shielded space. The provision of a number of tips has the advantage that a charge carrier cloud, also referred to as a streamer, can start from each tip. The tips preferably point in different directions, in particular in such a way that no two tips point in the same direction. The tips can be arranged such that the charge carrier clouds/streamers, considered together, take up a maximum volume. It has proven to be worthwhile to provide a ring from 4 to 7, in particular 5 to 7, electrode tips, which are arranged at equal distances from their neighbors.

The number of holes in the cap can be equal to the number of tips of the ignition electrode. Each tip of the electrode can be arranged opposite a hole in the cap. In this way, the torch jets produced during the ignition of the fuel/air mixture in the region of the streamers from the electrode tips easily leave the space shielded by the cap and effectively ignite the fuel/air mixture present in the combustion chamber. In principle, however, it is not necessary to provide exactly as many holes in the cap as the ignition electrode has tips, and the tips also do not necessarily each have to be arranged opposite a hole in the cap.

The insulator has a lateral surface, which may have an electrically conductive coating in an insulator section located in the outer conductor, said coating at least partially bridging any gaps present between the insulator and the outer conductor. In particular, the electrically conductive coating can be provided in the section surrounded by an external thread on the outer conductor/the housing of the ignition device. By means of such a thread the ignition device can be screwed into the cylinder head of an internal combustion engine. The conductive coating, at least in points, provides electrical contact between the insulator and the housing, such that the insulator is at the same electrical potential as the outer conductor/the housing. This promotes a good formation of the corona and therefore good ignition conditions. In particular, a layer based on one or more noble metals, for example a noble metal base alloy or a composite material based on one or more noble metals, is suitable as electrically conductive layer. A layer made of two noble metals can be formed for example by applying a paste to the insulator, said paste containing a mixture of two noble metal powders, for example a mixture of silver powder and a palladium powder. This paste can be applied to the insulator in a thickness from 10 μm to 20 μm, e.g. 15 μm, and can then be burned in.

The level of the ignition voltage, the volume of the space shielded by the cap and the shape of the space shielded by the cap can be matched to one another and to the compression in the combustion chamber of the engine for which the ignition device is intended, such that the corona discharge forming fills a maximum volume. The size and shape of the shielded space can be selected such that a transition of a corona discharge into a spark discharge between a tip of the ignition electrode and the cap is hindered and occurs only rarely, if at all. Said parameters can be matched such that a spark discharge does not occur under any circumstances between a tip of the ignition electrode and the cap. The occurrence of a spark discharge can be identified by monitoring the impedance of the series resonating circuit in which the capacitor formed from the ignition electrode and the cap is located. A spark discharge manifests itself in a sudden fall of impedance. If a spark discharge is identified in this way, a control device connected to the corona ignition device can reduce the voltage for following ignition processes.

The favorable influence on the ignition process caused by the cap shielding the electrode tips is also achieved when the cap is not attached to the outer conductor of the ignition device, but to the wall of the cylinder head of the internal combustion engine surrounding the site of installation of the ignition device. In this case, the tips of the ignition electrode only reach into the space shielded by the cap when the ignition device is screwed into the cylinder head, said space also reducing, in this embodiment, the stresses and loads of the tips of the ignition electrode caused by the combustion process.

The metal cap, on the inner side thereof may carry an electrically insulating layer, at least in a region or regions arranged opposite a tip of the ignition electrode. This refinement of this disclosure reduces the risk of an undesired spark discharge between one or more tips of the ignition electrode and the metal cap. This leads to the further advantage that the cap can be made smaller. The charge clouds (streamers) starting from the tips of the ignition electrode could then indeed reach the inner surface of the cap in some circumstances, but do not contact an electrically conductive surface there, but instead an electrically insulating surface, which hinders the transition of a corona discharge into a spark discharge. The possibility of making the cap smaller as a result of the coating of the inner side thereof with an electrically insulating material has the further advantage that the fuel/air mixture provided in the cap can be ignited more quickly and the cap can also be used in engines in which only little space is available for such a cap. A further advantage of the cap provided with an insulating layer on the inner side thereof lies in the fact that, with a given size of the cap, the corona discharge can be controlled such that the streamers are larger than with a metal cap which is not coated in an insulating manner, because the streamers no longer have to maintain such a large distance from the cap, as would be necessary with a purely metal cap.

The electrically insulating layer may extend into the one hole or the plurality of holes in the cap and cover the peripheral surfaces which delimit the holes in the cap. The electrically insulating layer may cover the peripheral surfaces inside a hole in part or completely. Due to this refinement of this disclosure, the risk that the corona discharge transitions into a spark discharge is further reduced.

Numerous materials are suitable for the electrically insulating layer on the cap. Of course, the material must be sufficiently temperature-resistant and resistant to burn-up in view of the conditions prevailing in the cap. Ceramic materials are considered primarily, for example an aluminium oxide ceramic. In addition, however, glazes, enamels, metal oxides, metal nitrides, metal carbides and metal borides are also possible.

Instead of a metal cap which is coated with an electrically insulating material on the inner side, a cap can also be used that consists on the whole from an electrically insulating ceramic material, for example from aluminium oxide. Such a cap cannot be welded to the outer conductor of the ignition device or to the cylinder head of the internal combustion engine, but instead could be connected to the outer conductor or to the cylinder head of the internal combustion engine by a joining method, for example by form-fit or force-fit clamping.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 shows an ignition device according to this disclosure in an oblique view,

FIG. 2 shows a simplified longitudinal section through the ignition device of FIG. 1,

FIG. 3 shows a more detailed longitudinal section through the front portion of the ignition device shown in FIG. 1,

FIG. 4 shows, as an enlarged detail, a front portion of the ignition device of FIG. 3 installed in a cylinder head of an internal combustion engine,

FIG. 5 shows a second embodiment of an ignition device according to this disclosure, installed in a cylinder head of an internal combustion engine with a cap fitted to the cylinder head, and

FIG. 6 shows a third embodiment of an ignition device according to this disclosure with a cap, which is coated on the inner side with an electrically insulating material.

### DESCRIPTION

The embodiments described below are not intended to be exhaustive or to limit the invention to the precise forms disclosed in the following detailed description. Rather, the embodiments are chosen and described so that others skilled in the art may appreciate and understand the principles and practices of this disclosure.

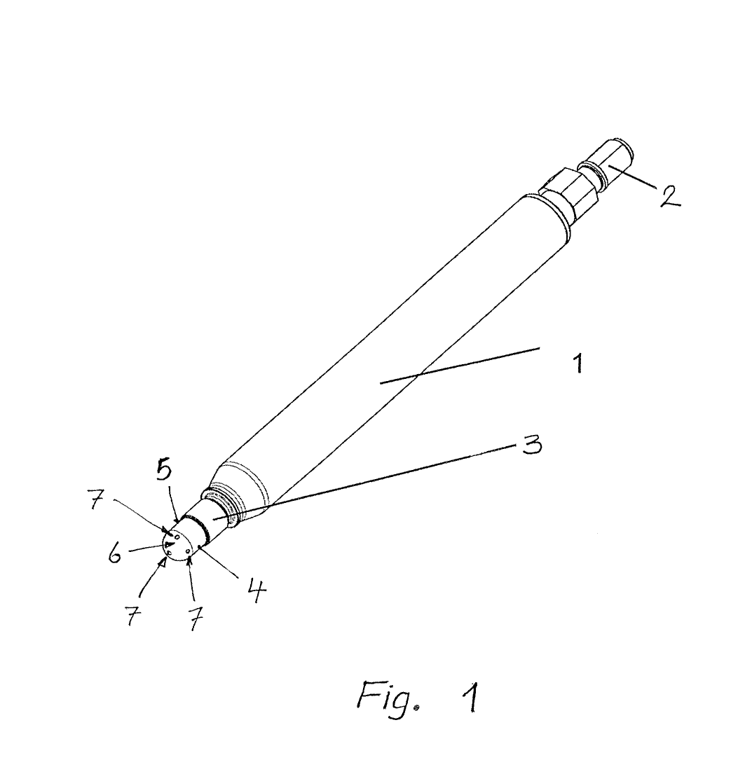

FIG. 1 shows an ignition device with a tubular housing 1 made of a metal material, which makes the housing simultaneously an outer conductor of the ignition device due to the electrical conductivity of said metal material. At the rear end of the housing 1, a high-frequency connector 2 is provided, via which the ignition device can be fed with a high-frequency electric voltage. At the front end of the tubular housing 1, a screw-in body 3 consisting of metal material is provided, which is fastened to the tubular housing 1 and is also part of the outer conductor. The screw-in body 3 in FIG. 1 has an external thread (not illustrated), by means of which said body can be screwed into a threaded bore of a cylinder head of an internal combustion engine. At the front end of the screw-in body 3, a cap 4 is fastened, consisting of a rear cylindrical portion 5 and a pre-curved, for example spherical dome-shaped front portion 6, in which holes 7 are provided. Tips of an ignition electrode, which are not visible in FIG. 1, are located beneath the cap 4.

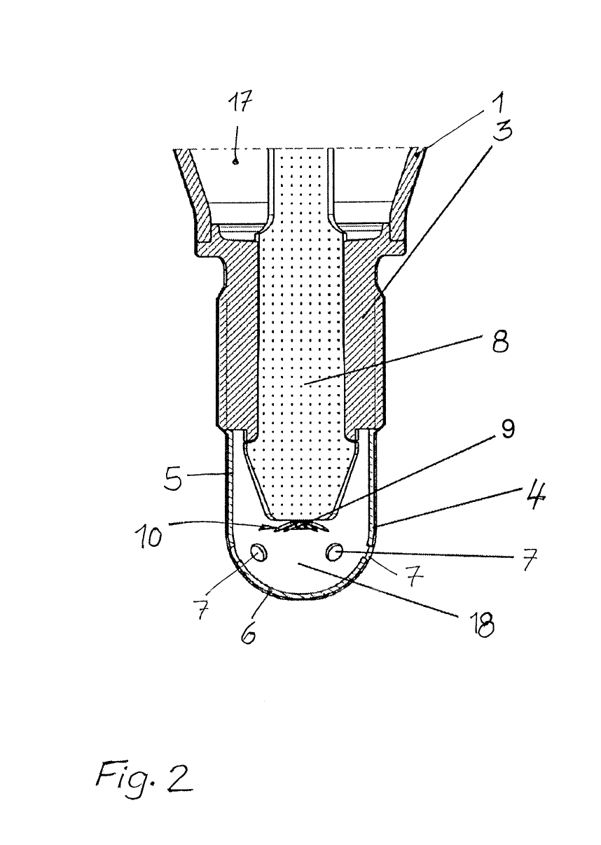

In the simplified longitudinal section of FIG. 2 through the ignition device, it is illustrated that the outer conductor provided by the tubular housing 1 and the screw-in body 3 surrounds an insulator 8, in which an ignition electrode 9 is embedded. The ignition electrode 9 branches into tips 10. Only some of the electrode tips 10 are illustrated in the simplified section of FIG. 2. The insulator 8 is not cut in FIG. 2, such that the embedded part of the ignition electrode 9 in FIG. 2 is not visible. Each of the electrode tips 10 is oriented such that it points in the direction of one of the holes 7 provided in the cap 4.

The insulator 8, which for example consists of sintered aluminium oxide, protrudes slightly from the screw-in body 3 into the space 18, which shields the cap 4 outwardly.

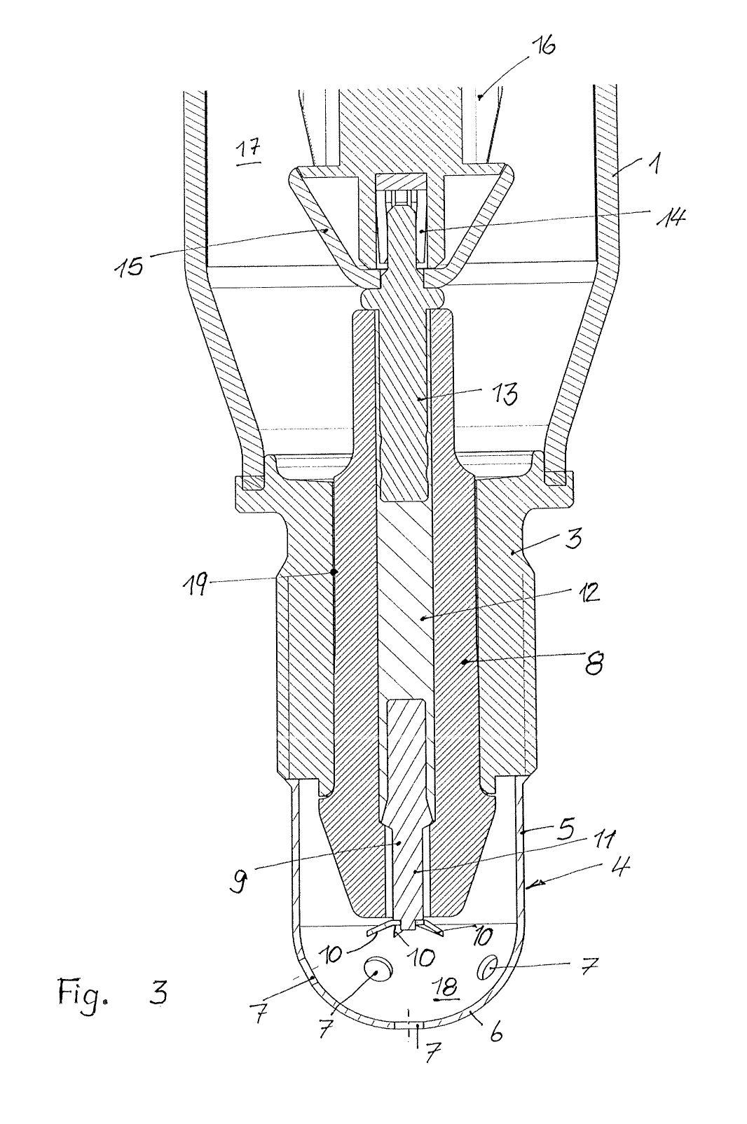

The insulator 8 is provided with a thin electrically conductive layer 19 (FIG. 3), which is located on the portion of the insulator 8 located in the screw-in body 3 and on a part of the portion of the insulator 8 protruding from the screw-in body 3 in order to ensure that the lateral surface of the insulator 8 has the same electric potential as the screw-in body 3, which is at ground potential once screwed into a cylinder head. The conductive layer 19 does not extend into the vicinity of the ignition electrode 9, but has a sufficient insulation distance therefrom.

FIG. 3 shows that the ignition electrode 9 has a shaft 11 extending rearward into the insulator 8 and connected by an electrically conductive glass element 12 to a second electrode 13, which has a rear end that is stuck into a contact bushing 14, which is housed in an electric shielding cover 15 and connects the second electrode 13 to the output of an electric coil 16, which is housed in the tubular housing 1 and is part of the series resonating circuit, which produces the corona discharge.

The coil 16 is housed in the tubular housing 1 in an electrically insulated manner. The necessary insulation between the coil 16 and the tubular housing 1 can be produced by a gas, by an electrically insulating casting compound, by an electrically insulating oil, or the like, which is filled into the annular gap 17 between the high-frequency coil 16 and the tubular housing 1. The tubular housing 1 serves simultaneously as a shielding against the leakage of high-frequency radiation from the housing 1.

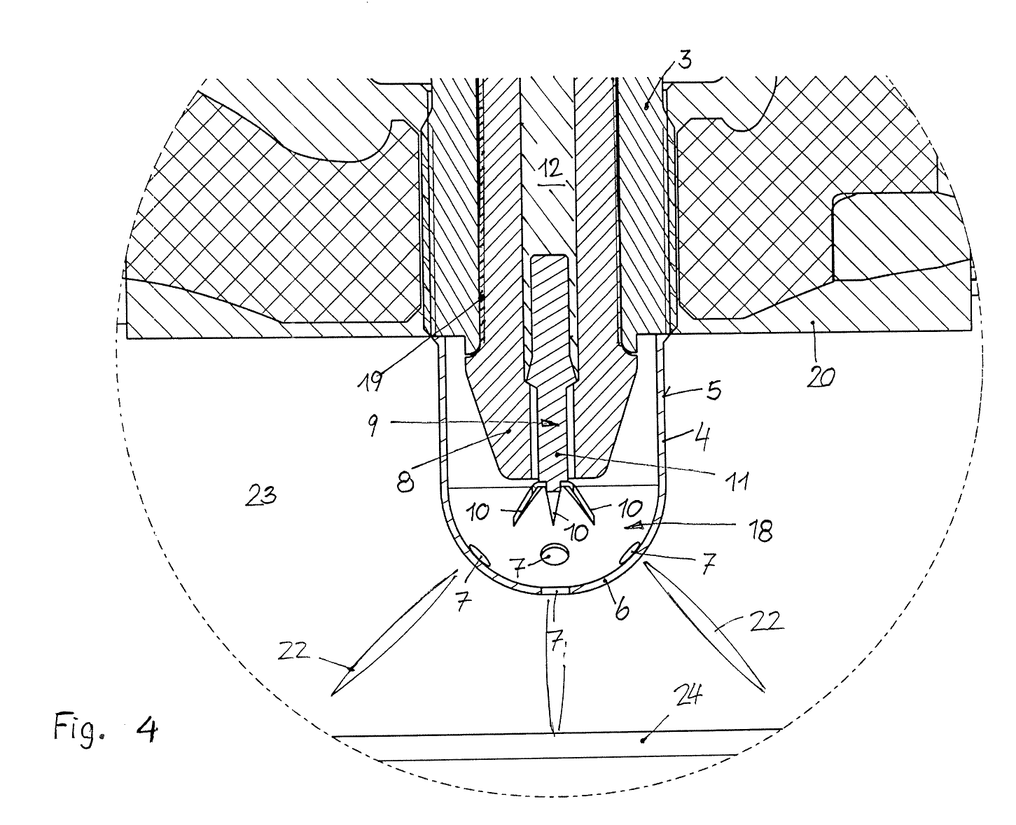

FIG. 4 shows the front portion of the ignition device screwed into a cylinder head 21. In this illustration, it can be seen that the ignition electrode 9 branches into six electrode tips 10, of which one is arranged centrally and runs in the longitudinal direction of the shaft 11 and five electrode tips 10 are arranged around the central electrode tip at equal distances from one another. Each electrode tip 10 is arranged opposite a hole 7 in the cap 4, of which four holes 7 are illustrated and two holes are located in the part of the cap 4 omitted by the section. Three torch jets 22 are illustrated schematically, which shoot through the holes 7 into the combustion chamber 23 following ignition of the fuel/air mixture present in the space 18 shielded by the cap 4, said combustion chamber being located between the cylinder head 21 and the cap 4 on one side and a piston 23 of the internal combustion engine on the other side.

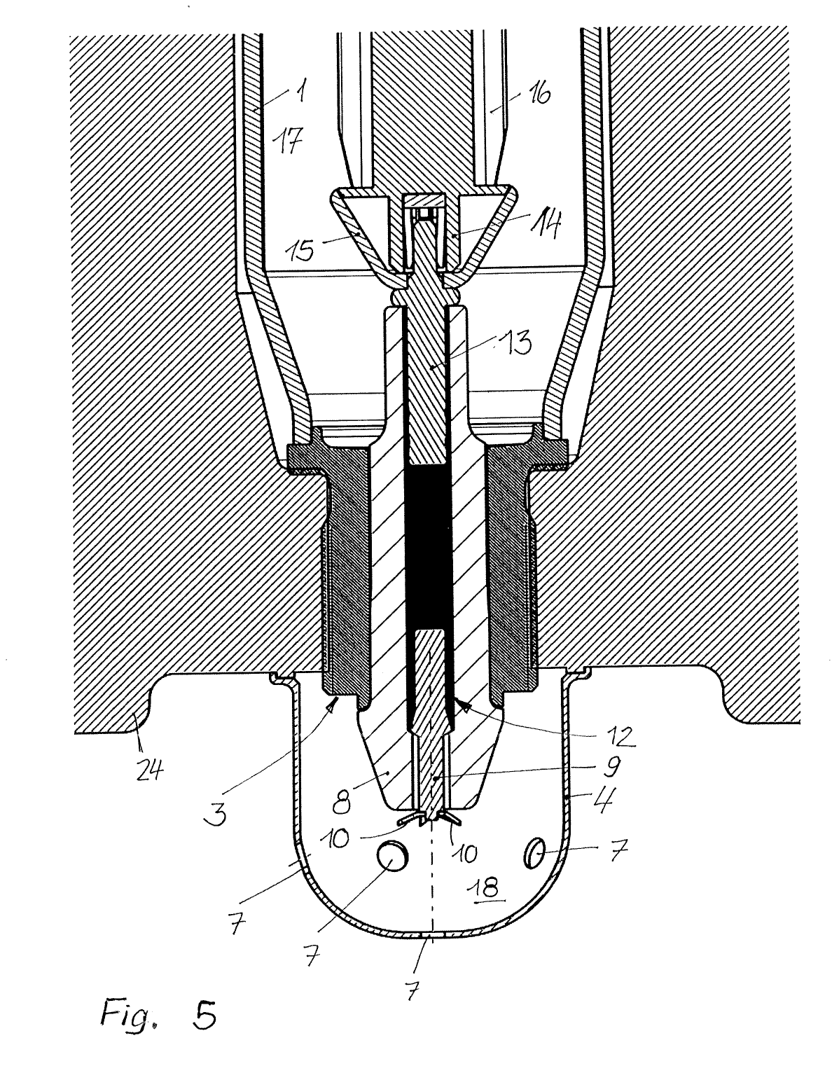

The embodiment illustrated in FIG. 5 differs from the embodiment illustrated in FIG. 4 in that the cap 4, which shields the electrode tips 10, is not fastened to the screw-in body 3 of the ignition device, but to the cylinder head 21. When the ignition device is screwed into the cylinder head 21 the electrode tips 10 are each directed in the direction of a hole 7, which can be ensured for example by providing a marking at the rear end of the ignition device.

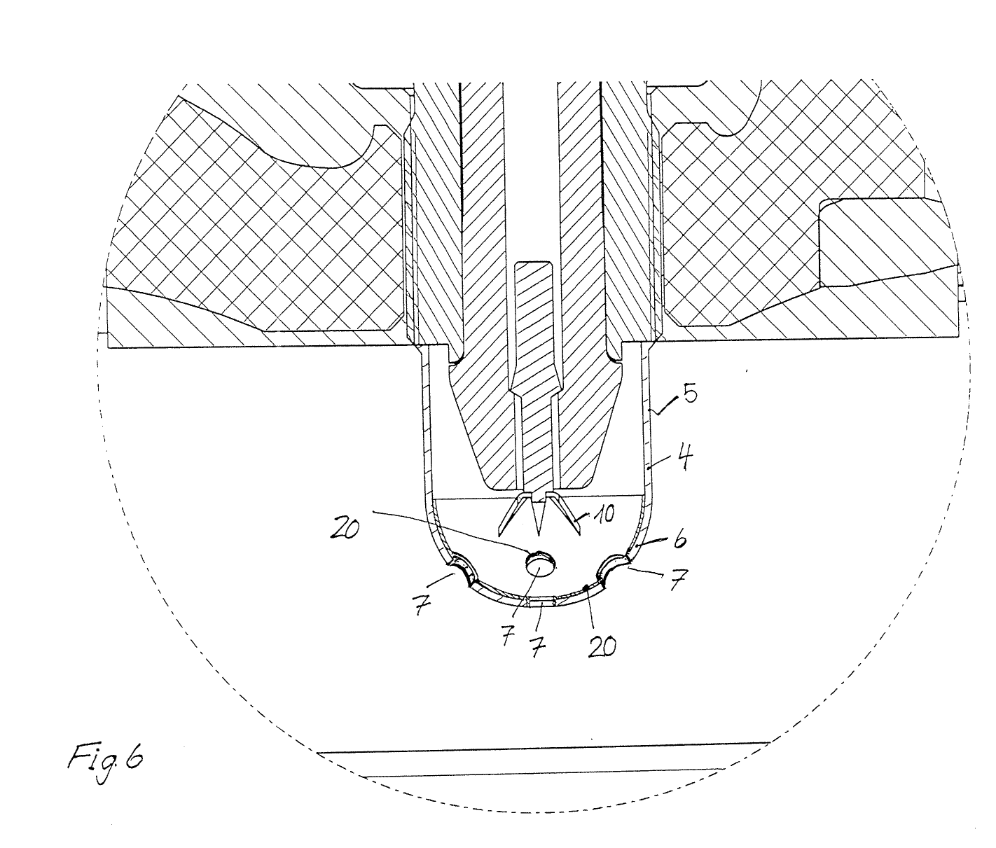

The embodiment illustrated in FIG. 6 differs from the embodiment illustrated in FIG. 4 in that the pre-curved front portion 6 of the cap 5 inclusive of the peripheral wall delimiting the holes 7 is covered by a layer 20 made of an electrically insulating material, in particular made of a ceramic material. Such a layer can be produced for example by flame spraying or by dipping into a slurry of a ceramic powder and subsequent burning in.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

### LIST OF REFERENCE SIGNS

1 tubular housing
2 high-frequency connection
3 screw-in body
4 cap
5 cylindrical portion of the cap
6 pre-curved front portion of the cap
7 holes
8 insulator
9 ignition electrode
10 electrode tips
11 shaft
12 conductive glass element
13 second electrode
14 contact bushing
15 shielding cover
16 coil
17 annular gap
18 shielded space
19 conductive layer on 8
20 electrically insulating layer
21 cylinder head
22 torch jets
23 combustion chamber
24 piston

What is claimed is:

1. An ignition device for igniting fuel/air mixtures in a combustion chamber of an internal combustion chamber by a corona discharge, the ignition device comprising:
an ignition electrode;
an outer conductor surrounding the ignition electrode, the outer conductor having front and rear ends;
an electrical insulator arranged between the ignition electrode and the outer conductor, at least one tip of the ignition electrode protruding from the insulator; and
a cap associated with the insulator, wherein at least one tip of the ignition electrode is arranged in a space that is shielded by the cap, the cap having an inner side facing the insulator and an outer side facing away from the insulator, the cap including one or more holes connecting the shielded space to a space arranged on the outer side of the cap.

2. The ignition device according to claim 1, wherein the cap is formed of metal.

3. The ignition device according to claim 2, wherein the cap is formed of the same material as the outer conductor.

4. The ignition device according to claim 2, wherein the metal cap, on the inner side thereof, carries an electrically insulating layer, at least in a region that is arranged opposite the tip or one of the tips of the ignition electrode.

5. The ignition electrode according to claim 4, wherein the electrically insulating layer also protrudes into the plurality of holes in the cap, and covers peripheral surfaces inside the holes.

6. The ignition device according to claim 4, wherein the material of the electrically insulating layer is selected from the following group: ceramic materials, glazes, enamels, metal oxides, metal nitrides, metal carbides, metal borides.

7. The ignition device according to claim 1, wherein the ignition electrode is branched into a number of tips, which protrude into the shielded space.

8. The ignition device according to claim 7, wherein the tips of the ignition electrode point into different directions.

9. The ignition device according to claim 7, wherein the number of holes in the cap is the same as the number of tips of the ignition electrode.

10. The ignition device according to claim 7, wherein the cap is formed of a ceramic and is joined to the outer conductor of the ignition device or to the cylinder head of the internal combustion engine.

11. The ignition device according to claim 1, wherein each tip of the ignition electrode is arranged opposite a hole in the cap.

12. The ignition device according to claim 1, wherein the insulator has a lateral surface, which has an electrically conductive layer at least in a section that is located in the outer conductor, said layer bridging a possible gap between the insulator and the outer conductor.

13. The ignition device according to claim 1, wherein the cap is attached to or formed on the front end of the outer conductor.

14. The ignition device according to claim 1, wherein the cap is attached to or formed on a combustion chamber wall of the internal combustion engine.

15. The ignition device according to claim 1, wherein the ignition voltage and the size and shape of the space shielded by the cap are matched to one another and to the compression in the combustion chamber of the engine, whereby the occurrence of the corona discharge transitioning into a spark discharge is significantly reduced.
